(19) United States
(12) Patent Application Publication
(10) Pub. No.: US 2007/0289114 A1
(43) Pub. Date: Dec. 20, 2007

(54) INSTALLATION TOOL FOR WIRE THREAD INSERTS

(75) Inventors: SIMON JAMES BOWEN, VERMONT (AU); PETER VENETIS, MELBOURNE (AU)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: ALCOA GLOBAL FASTENERS, INC.

(21) Appl. No.: 11/759,873

(22) Filed: Jun. 7, 2007

(30) Foreign Application Priority Data
Jun. 19, 2006 (AU) 2006903308

(51) Int. Cl. B23P 19/04

(52) U.S. Cl. 29/240.5

(57) ABSTRACT

An installation tool for a wire thread insert having an inner surface with an inner helical thread, and an outer surface with an outer helical thread, the installation tool including: an elongate body (1) having a passage (3) extending there through between opposing ends thereof; a mandrel (5) supported within said passage and movable parallel to and rotatable about an elongate axis of the passage (3), the mandrel having a threaded portion (15) at one end thereof upon which a said wire thread insert can be threaded; wherein a delivery nozzle (21) having a threaded discharge port (17) is provided at one end of the tool for engaging the outer helical thread of a said wire thread insert, at least the delivery nozzle (21) being formed of a self-lubricating material.

### RELATED APPLICATIONS

This application claims the benefit of and priority to Australian Provisional Application No. 2006903308, filed on Jun. 19, 2006, the contents of which are incorporated by reference herein in its entirety.

### FIELD OF THE INVENTION

The present invention is generally directed to wire thread inserts used in the repair of pre-existing threaded bores having a damaged thread, or to form a new thread for a bore within a substrate, and is in particular directed to an installation tool for installing such wire thread inserts.

### BACKGROUND OF THE INVENTION

Wire thread inserts are conventionally provided by a wire formed into a closed coil configuration, with the coiled insert having an inner and outer surface. The cross-section of the wire is typically diamond shaped and is coiled such that one portion of the coiled wire forms an inner helical thread for the inner surface of the insert, while the other portion of the coiled wire forms a second helical thread for the outer surface of the insert which is adapted to engage a helical thread provided in a bore within a substrate.

These wire thread inserts are typically used to repair threaded bores where the thread has been damaged or stripped. They can also be used to provide a new thread for a bore.

The normal procedure for repairing an existing threaded bore and for installing such a wire thread insert is as follows:

a) passing a drill bit through the bore to clean out and remove the remaining sections of the original helical thread;

b) using a tap to provide a new helical thread within the drilled bore, this helical thread having a diameter greater than the original helical thread of the bore;

c) inserting the wire thread insert by means of a installation tool which engages a tang or notch on the inner surface provided at the end of the insert and twists and temporarily narrows the diameter of the insert thereby allowing the insert to enter and engage the female helical thread in that bore;

d) releasing the insert such that it springs outwardly again to more tightly engaging the threaded bore; and

e) finally breaking or twisting off the tang when and if provided at the end of the wire thread insert.

A torsional force may be applied to the wire thread insert to thereby initially twist and compress that insert such that it can be readily wound into the helical thread. Once the torsional force is removed from the thread insert, that insert expands outwardly to secure the engage the female helical thread provided within the threaded bore. Alternatively, the installation tool can compress the insert prior to and during installation of the insert. This ensures that the thread insert remains securely in place when a bolt is subsequently inserted and engages the new female helical thread provided by the inside surface of that thread insert. A similar procedure is followed where the insert is being used to provide a new helical thread within a bore.

Different types of installation tool may be used for the installation of the wire thread inserts. The simplest type of installation tool includes a mandrel having a slot at one end for engaging a tang on the wire thread inserts and applying a torsional force to that insert during installation. Another type of installation tool utilizes a threaded mandrel and may be used for both wire thread inserts with tangs or tangless wire thread inserts. This installation tool has a body machined from metal alloy and supports the mandrel therein. A handle is provided at one end of the mandrel to allow the mandrel to be manually driven for rotation. The opposing end of the mandrel is provided with a male thread which can engage the inner helical thread of a wire thread insert. Adjacent the threaded end of the mandrel is provided the delivery end of the tool from which the wire thread insert is driven into the bore. A female threaded discharge port is formed into the delivery end of the installation tool for engaging the outer surface of the wire thread insert prior to and during installation of the insert to thereby compress the insert.

Conventional threaded mandrel installation tools have a number of disadvantages. Firstly, there is a tendency for “galling” of the insert within the nozzle during the installation procedure. There is therefore resistance to the movement of the wire thread insert, which is typically made from alloy steel, through the discharge nozzle, which is also made from steel. The installation tool includes a side entrance adjacent the delivery end of the tool to allow the insert to be loaded into the passage of the tool prior to installation. Conventional installation tools requires the mandrel to be retracted to clear the passage adjacent the side passage prior to the loading of the insert. The mandrel is provided with a handle which is manually turned to thereby allow for rotation of the mandrel. The conventional threaded mandrel installation tools cannot therefore be readily adapted for power drive applications. Furthermore, the cost of producing an installation tool having a machined body is relatively high.

### SUMMARY

It is therefore an object of the present invention to provide an installation tool for wire thread inserts that overcomes at least one of the disadvantages of conventional installation tools.

With this in mind, the present invention provides an installation tool for a wire thread insert having an inner surface with an inner helical thread, and an outer surface with an outer helical thread, the installation tool including an elongate body having a passage extending there through between opposing ends thereof;

a mandrel supported within said passage and movable parallel to and rotatable about an elongate axis of the passage, the mandrel having a threaded portion at one end thereof upon which a said wire thread insert can be threaded wherein a delivery nozzle having a threaded discharge port is provided at one said end of the tool for engaging the outer helical thread of a said wire thread insert;

at least the delivery nozzle being formed of a self-lubricating material.

The self-lubricating material may include an anti galling, low friction alloy such as brass although the use of other materials having similar properties are also envisaged. The use of such material minimizes or prevents galling the insert with the discharge port while the insert is being delivered. Preferably the delivery nozzle is formed of this material, with the remainder of the body being formed of another material such as polymer. It is however envisaged that the entire body be formed of brass or another self-lubricating material.

The body may include a side entrance adjacent the delivery end of the tool to allow for an insert to be loaded into the passage.

Resilient means may be provided for retracting the threaded end of the mandrel away from the portion of the passage accessible by said side entrance during said loading. The resilient means may preferably be in the form of a coil spring inserted within and engageable with shoulder within the passage within the body and with a shoulder provided on the mandrel.

This arrangement ensures that the mandrel is retracted from and does not obstruct the passage adjacent the side entrance following installation of an insert. A new insert can then be loaded into the passage immediately without needing to first retract the mandrel.

The opposing end of the mandrel to the threaded end may be provided with an engagement head which may be adapted to engage a power tool to facilitate rotation of the mandrel. The drive end of the mandrel may for example be in the form of a hex drive. The engagement had could also engage a manual actuator such as a knob.

The installation tool may be used in the following manner:

A wire thread insert is inserted through the side entrance into the passage of the body. It is unnecessary to retract the mandrel from that portion of the passage because the resilient means acts to urge the mandrel away from this area.

A power drive such as a power tool may engage the engagement head of the mandrel to facilitate the threading of the wire thread insert onto the fitted portion of the mandrel as well as allowing the insert to be threaded into the threaded delivery nozzle. The use of a nozzle made from material such as brass prevents or at least minimizes galling of inserts made of alloy steel as the insert is threaded through the nozzle into the bore.

### DRAWINGS

It will be convenient to further describe the invention with respect to the accompanying drawings which illustrate a preferred embodiment of the installation tool according to the present invention. Other embodiments of the invention are possible, and consequently, the particularity of the accompanying drawings is not to be understood as superseding the generality of the preceding description of the invention.

In the drawings:

FIG. 1 is a perspective view of a prior art installation tool;

FIG. 2 is a side cross-sectional view of a body of the installation tool according to the present invention;

FIG. 3 is a side cross-sectional view of a delivery nozzle of the installation tool according to the present invention;

FIG. 4 is a side view of a mandrel of the installation tool according to the present invention;

FIGS. 5a, b and c are respectively detailed views of the threaded end of the mandrel of FIG. 4; and

FIGS. 6a and b are respectively end and side cross-sectional views of a knob for the installation tool according to the present invention.

### DETAILED DESCRIPTION

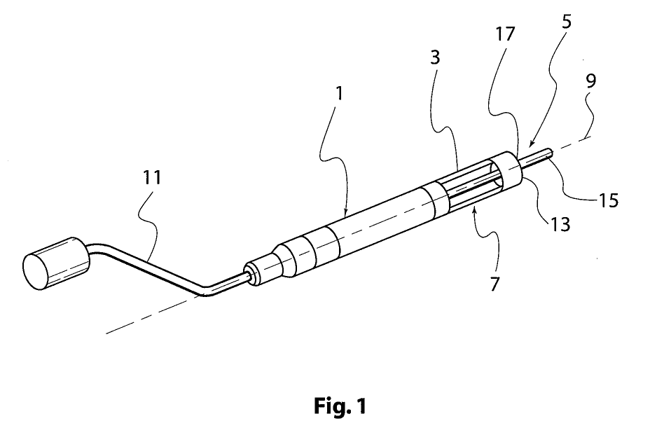

FIG. 1 shows a prior art installation tool for installing wire thread inserts. This installation tool includes a body 1 having a passage 3 extending completely through the body 1. The passage 3 accommodates a mandrel 5 which can move through such passage 3 parallel to an elongate axis 9 of the body 1. The mandrel 5 can also rotate about the elongate axis 9 by means of a crank handle 11. A side passage 7 is provided within the body to allow wire thread inserts to be loaded into the passage 3 adjacent the delivery end 13 of the installation tool. The mandrel is provided with a threaded end 15 which is adapted to engage an inner helical thread of the wire thread insert following loading of that insert into the passage 3. The delivery end 13 further includes a threaded discharge port 17 which is adapted to engage the outer helical thread of the insert during the installation of that insert.

The following figures illustrate features of the installation tool of the present invention, and the same reference numerals are therefore used for corresponding features of the prior art installation tool for clarity reasons.

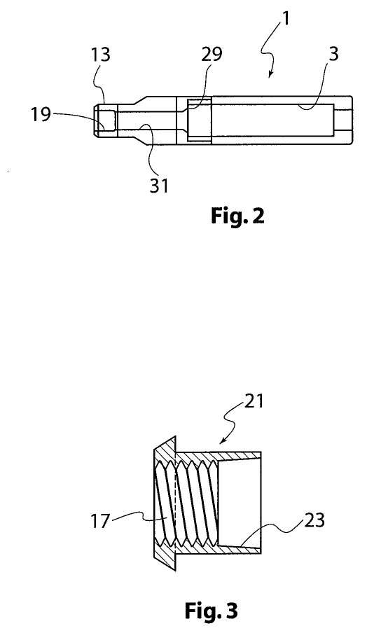

FIG. 2 shows in more details features of the body 1 of the installation tool according to the present invention. The body 1 includes a passage 3 ending in a delivery end 13 of the body 1. The delivery end is provided with a cylindrical bore 19 for accommodating a delivery nozzle 21 shown in FIG. 3. The delivery nozzle 21 is made of a self-lubricating material such as brass, whereas the body 1 can be made of a plastic material such as ABS plastic. The delivery nozzle 21 includes a threaded discharge port 17 for engaging the outer helical thread of the insert. Immediately upstream of the discharge port 17 is a frusto-conical shaped cavity 23 for helping to guide the insert into the discharge port 17.

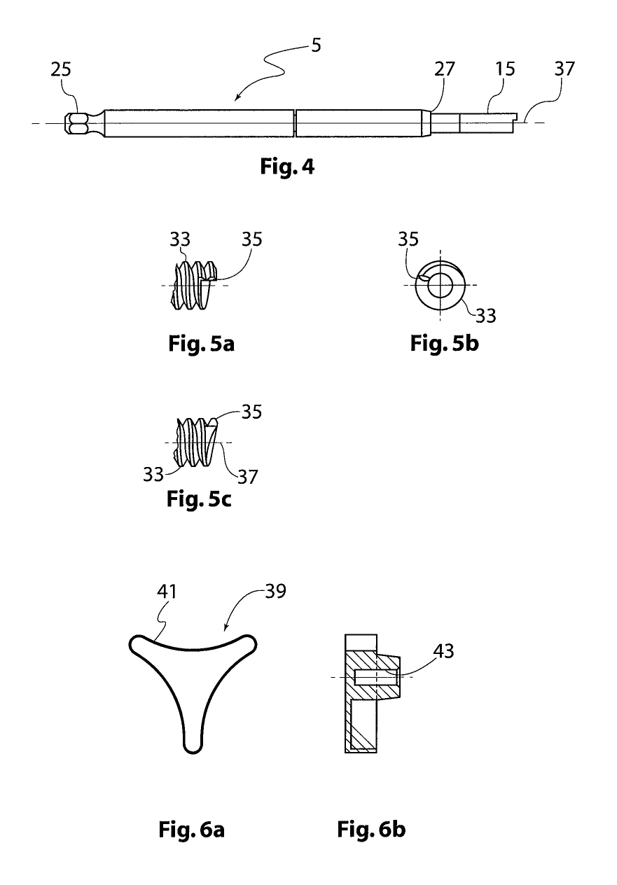

FIG. 4 shows in more detail the various features of the mandrel 5 which is accommodated by the passage 3 for both axial and rotational movement therein. The mandrel 5 includes a threaded end 15 and an opposing engagement head 25 located at the other end thereof. The threaded end 15 extends from a shoulder portion 27 provided on the mandrel. An opposing shoulder 29 is also provided within the passage 3 of the body 1 (as shown in FIG. 2). This allows a resilient means such as a coil spring (not shown) to be accommodated between the mandrel shoulder 27 and passage shoulder 29. The resilient means acts to urge the mandrel 5 in a direction away from the delivery end 13 to thereby facilitate loading of inserts into a chamber 31 located immediately upstream of the delivery end 13 and forming part of the entire passage 3. A side passage (not shown) is provided within the body immediately adjacent this chamber 31 to allow for inserts to be inserted into that chamber.

FIGS. 5a to c show in more detail the threaded end 15 of the mandrel 5. FIG. 5a is a detailed view of the end portion of the threaded end 15, while FIG. 5b is a view of the threaded end shown in FIG. 5a rotated 90° about the elongate axis 37 of the mandrel. FIG. 5c is an end view of the threaded end 15. A helical head 33 winds around the threaded end 15 for engaging an inner helical thread of the insert. This helical thread 33 ends in an abutment 35 which is adapted to engage either a tang provided at an end of the insert or an abutment notch in the case of tangless inserts.

The engagement head 25 of the mandrel is in the form a hex head which allows for the mandrel 5 to be driven for rotation about its elongate axis 37 by a power tool. Alternatively, the mandrel 5 may be manually rotated by means of a knob 39 as shown in FIGS. 6a and 6b. FIG. 6a shows an end view of the knob having three arms 41 to facilitate rotation thereof. FIG. 6b is a side cross-sectional view of the knob showing the engagement passage 43 which fits over the engagement end 25 of the mandrel.

The use of delivery nozzle 21 formed from self-lubricating material such as brass minimizes or prevents galling of the insert as it passes through the threaded discharge port 17. The use of plastics to form the body 1 reduces the overall manufacturing costs of the installation tool according to the present invention as well as making the tool significantly lighter. Furthermore, the installation tool according to the present invention does not require the mandrel 5 to be retracted every time a new insert needs to be inserted into the chamber 31 as the mandrel 5 is always urged in a retracted position away from the chamber 31 until such time as the threaded end 15 of the mandrel is required to engage the insert. The installation tool according to the present invention also facilitates the use of power tools to rotate the mandrel 5 thereby ensuring quicker installation of inserts by the tool.

Modifications and variations as would be deemed obvious to the person skilled in the art are included within the ambit of the present invention as claimed in the appended claims.

1. An installation tool for a wire thread insert having an inner surface with an inner helical thread, and an outer surface with an outer helical thread, the installation tool including:
an elongate body having a passage extending there through between opposing ends thereof;
a mandrel supported within said passage and movable parallel to and rotatable about an elongate axis of the passage, the mandrel having a threaded portion at one end thereof upon which a said wire thread insert can be threaded;
wherein a delivery nozzle having a threaded discharge port is provided at one end of the tool for engaging the outer helical thread of a said wire thread insert, at least the delivery nozzle being formed of a self-lubricating material.

2. An installation tool according to claim 1, wherein at least the delivery nozzle is formed from an anti galling, low friction alloy.

3. An installation tool according to claim 1 or 2 wherein the body includes a side entrance adjacent the delivery end thereof for allowing a said wire thread insert to be loaded into the passage and resilient means for retracting the threaded end of the mandrel away from the portion of the passage accessible by said side entrance during said loading.

4. An installation tool according to claim 3, wherein the resilient means includes a coil spring located within the passage and respectively engaged with a shoulder within the passage and a shoulder provided in the mandrel.

5. An installation tool according to claim 1 wherein the opposing end of the mandrel is provided with an engagement head adapted to engage a power tool for rotating the mandrel.
